(19) United States
(12) Patent Application Publication
(10) Pub. No.: US 2013/0307438 A1
(43) Pub. Date: Nov. 21, 2013

(54) Centroidal Cycltron Charged Paticle Accelerator

(71) Applicant: Mark Edward Morehouse, Costa Mesa, CA (US)

(72) Inventor: Mark Edward Morehouse, Costa Mesa, CA (US)

(21) Appl. No.: 13/473,594

(22) Filed: May 17, 2012

(51) Int. Cl. H05H 13/00

(52) U.S. Cl. 315/502

(57) ABSTRACT

The Centroidal Cyclotron reveals an apparatus and method for accelerating and trapping charged particles in a solenoid magnetic field. An oscillating electric field is applied generally transverse to the magnetic field axis accelerating and trapping charged particles by their inherent cyclotron frequency at a given magnetic field of the solenoid magnetic field producing charged particle orbits with minimum canonical angular momentum orbits and gyro-phase synchrony.

### FIELD OF THE INVENTION

The present invention relates generally to the field of charged particle acceleration, trapping and collisional interaction. And more specifically to a cyclotron Radio Frequency charged particle accelerator that produces charged particle orbits with minimum canonical angular momentum orbits and gyro-phase synchrony.

### BRIEF DESCRIPTION OF THE INVENTION

The present Patent Letters describes an apparatus and method which provides benefits and advantages over the Prior Art with regards acceleration, confinement, trapping neutralization, control and manipulation of charged particle orbits in a vacuum magnetic field. A method and apparatus for acceleration and manipulation of charged particles operating within a solenoid magnetic field having an axis of symmetry and supported within a vacuum space is herein revealed. Acceleration, confinement, trapping, control and manipulation of charged particles is attained by means of application of alternating electric fields to charged particles within a vacuum magnetic field. The Centroidal Cyclotron acts on particle orbits that have low to zero canonical angular momentum. Although an additional benefit is that it may be capable of producing low to zero canonical angular momentum orbits from any prior state of particle orbits. Low or zero canonical angular momentum orbits approach or pass through the magnetic field axis once each cycle. The Centroidal Cyclotron applies an alternating electric field at the cyclotron frequency of the particles between two electrodes, thus achieving acceleration of the particles confined within the vacuum magnetic field. Wherein the vacuum magnetic field has varying values within the vacuum space, the Centroidal Cyclotron, by virtue of varying frequencies may control the positioning of charged particles according to the equation relating cyclotron frequency and magnetic field, as described below.

### BACKGROUND OF THE INVENTION

Cyclotron charged particle accelerators operate on particles within a magnetic field. The cyclotron frequency varies with the magnetic field, while energy (non-relativistic) does not change the cyclotron frequency at a given magnetic field strength. Thus the cyclotron frequency, ω=q/m*B, where q is charge, m is mass and B is the magnetic field value. As can be seen by the above equation, the frequency is energy independent. This fact is critical to the operation of cyclotrons. Radio Frequency (RF) electric fields are used for acceleration of charged particles. In linear accelerators RF fields accelerate charged particles bunches from one RFQ (radio frequency quadruple) to another. RF is also used, more relevantly to the present patent letters, in Cyclotron accelerators as well as Synchrocyclotron accelerators as well as the Isochronous Cyclotron. In the original cyclotron, Lawrence, U.S. Pat. No. 1,948,384, RF energy is applied between two “Dees” which present alternating electric field potentials once each half cycle. The charged particles are inside one or the other Dee as the polarity of the RF signal is reversed. The charged particles are thus accelerated in a plane perpendicular to the magnetic field axis. The charged particles are accelerated twice per revolution and each pass causes the charged particles to assume a larger orbit, until the charged particle's reach the periphery of the field whereupon they are extracted. In the synchrocyclotron the RF frequency changes, because the charged particles are accelerated towards relativistic velocities, resulting in a change of the frequency of rotation, which is independent of energy, and depends only on charge to mass ratio. The Isochronous Cyclotron allows the RF field frequency to remain unchanged despite a relativist increase in apparent mass, by providing an increasing magnetic flux at greater radii. Such accelerators operate on particles that encircle the magnetic field axis, and have not been applied to low or zero canonical angular momentum orbits.

Many papers and patents have been issued regarding the aforementioned family of cyclotron accelerators. Beginning with the works of Leo Szilard and Rolf Wideroe many types of accelerators have been developed. Lawrence, U.S. Pat. No. 1,948,384, introduces the concept of the Cyclotron accelerator, which provides benefits over previous accelerators to produce high energy particles. Utilizing a relatively low voltage to achieve high energy, a cyclotron, by repeated application of the oscillating voltage, produces high energy particles. Because the cyclotron frequency is a function of the charge to mass ratio, as a particle approaches relativistic velocities, the cyclotron frequency changes, limiting the usefulness of the basic cyclotron. To overcome the relativistic limitation Edwin McMillan U.S. Pat. No. 2,615,129, invented the Synchrocyclotron, which allows the cyclotron frequency to change over the period of acceleration. In its turn the Synchrocyclotron suffers from the limitation that, since it changes it's frequency as the particles accelerate, it can only act on a single bunch of particles that have the proper time dependent energy. To overcome this limitation the Isochronous Cyclotron was developed. An example of the Isochronous Cyclotron is found in Delphin U.S. Pat. No. 3,789,335 and Karasawa U.S. Pat. No. 4,353,033, and many others.

No Prior Art has been identified that attempts to produce a cyclotron frequency accelerator for particle orbits that cross the axis of magnetic symmetry. Although a couple of patents that reference devices that confine particles that cross the magnetic axis are W. H. Bennett U.S. Pat. No. 3,120,475 and B. Maglich et. al. U.S. Pat. No. 4,788,024, incorporated herein be reference.

### BRIEF DESCRIPTION OF THE DRAWINGS

Drawing FIG. 1 is an axial cross section revealing a solenoid magnetic field 25 produced by magnetic field coils 20 in a vacuum space (not shown) having an axis of symmetry 40. The Centroidal Cyclotron accelerator requires a set of electrodes 30 and 35. The two electrodes are energized at the particle 50, 55 cyclotron frequency by means of an RF source 10.

FIG. 2 shows an axial cross section of a solenoid magnetic field 25 produced by magnetic field coils 20 in a vacuum space not shown having an axis of symmetry 40. A number of intermediate peripheral electrodes 37 operating on either side of a trapped population of charged particles 50 and 55 are capable of setting a limit to the energy that the charged particles can attain.

FIG. 3 shows an axial cross section of a solenoid magnetic field 25 produced by magnetic field coils 20 in a vacuum space not shown having an axis of symmetry 40. A number of intermediate peripheral electrodes 37 operating on either side of a trapped population of charged particles 50 are capable of trapping charged particles 55 at a given magnetic field strength position.

### DETAILED DESCRIPTION OF THE INVENTION

The present Patent Letters teaches certain benefits and advantages for the acceleration and confinement of charged particles. The Centroidal Cyclotron The Centroid Cyclotron beam accelerator operates on orbits that cross the magnetic field axis once each cycle. Orbits that cross the magnetic field axis once each cycle are referred to as low or zero canonical angular momentum orbits. The charged particles therefore have two distinguishable states, approaching the center and approaching the periphery. This feature is unique to these type of orbits. The RF oscillations are therefore applied between the axis of the magnetic field and the periphery of the charged particles orbits. The Centroidal Cyclotron does not require that the charged particles be shielded from the RF during the cycle transition, as is found in the cyclotron. The charged particles are exposed to the RF energy the entire time that the RF is operating and they are confined in the magnetic field. The Centroid Cyclotron, as is common to RF based cyclotrons in general, only acts positively on charged particles that possess the proper phase. Charged particles that are out of phase are decelerated, causing the charged particles to become in phase with the applied oscillating RF electric field, while those that are in phase are accelerated continuously. Thereby the charged particle population acquires gyro phase coherence. Gyro phase coherence refers to the tendency for the whole charged particle population to have synchronized orbits, in this case radial synchrony. The result of radial synchrony is that the density of the beam fluctuates with each cycle. This is not the case in the standard cyclotron operation, nor the linear accelerator. As the charged particles approach the axis the density goes up and as they leave the axis the density goes down also as they approach the radial periphery the density goes back up, but not nearly as much. The collisional energy goes up as the particle population approaches the axis, especially the center of mass collisional energy. So the interaction likelihood, which is strongly energy dependant, is strongly favored on axis. The degree of density growth depends upon the axial extent of the confinement geometry, the charged particle population number, the value of the canonical angular momentum and the gyro phase coherence.

Drawing FIG. 1 is an axial cross section revealing a solenoid magnetic field 25 produced by magnetic field coils 20 in a vacuum space (not shown) having an axis of symmetry 40. A preferred embodiment of the Centroidal Cyclotron operates with a solenoidal magnetic field 25 established in a vacuum space (not shown) by means a set of solenoid coils 20. Said solenoid coils are shown as a minimum set of two coils. The solenoid field may be established by any number of field coils 20 positioned and constructed of such shape as to achieve the intended objective of the invention. The solenoid field 25 may incorporate ferromagnetic pole pieces (not shown) and or be composed of superconducting or resistive coils 20 as to achieve the intended objective of the invention and as is well known in the field. The general shape of the magnetic field and the vacuum space may be of any desired extent, both axial and radial, as required for the particular embodiment and application, as is well known in the field. The Centroidal Cyclotron accelerator requires a set of two electrodes 30 and 35. The two electrodes are energized at the particle cyclotron frequency by means of an RF source 10. The RF source 10 is capable of providing electrical potentials and currents as required by the particular embodiment and application, as is well known in the field. One of the RF electrodes 35 is situated at the periphery (peripheral electrode) of the confinement magnetic field beyond the furthest radial extent of the particle trajectory. The second electrode is a virtual electrode at the axis (central electrode). The central electrode is situated on the magnetic field axis 40. The central electrode 35 may be situated on either or both ends of the solenoid magnetic field but are out of the plane of the charged particle orbits 50 and 55 and communicates with the charged particles 50 and 55 via the unrestrained conductivity of charges to move along magnetic field lines. The electric field of the central electrode is therefore conducted through charges from the axial electrode, to the plane of the orbits, via the enhanced electrical conductivity along the field lines. The axial electrode is therefore a virtual electrode. An electrode on a magnetic field line 25 generally establishes a potential on that line and such magnetic field line potentials are referred to as equipotentials lines. Either or both of said electrodes may incorporate an electron source within the vacuum space confining the charged particle orbits 50 and 55. The particle is accelerated from it's initial smaller orbit 50 to a larger orbit 55. The method of introduction of the charged particle source is not addressed here but refer to M. Morehouse U.S. Pat. No. 8,138,677 and M. Morehouse U.S. Pat. No. 7,825,601, incorporated hereby by reference.

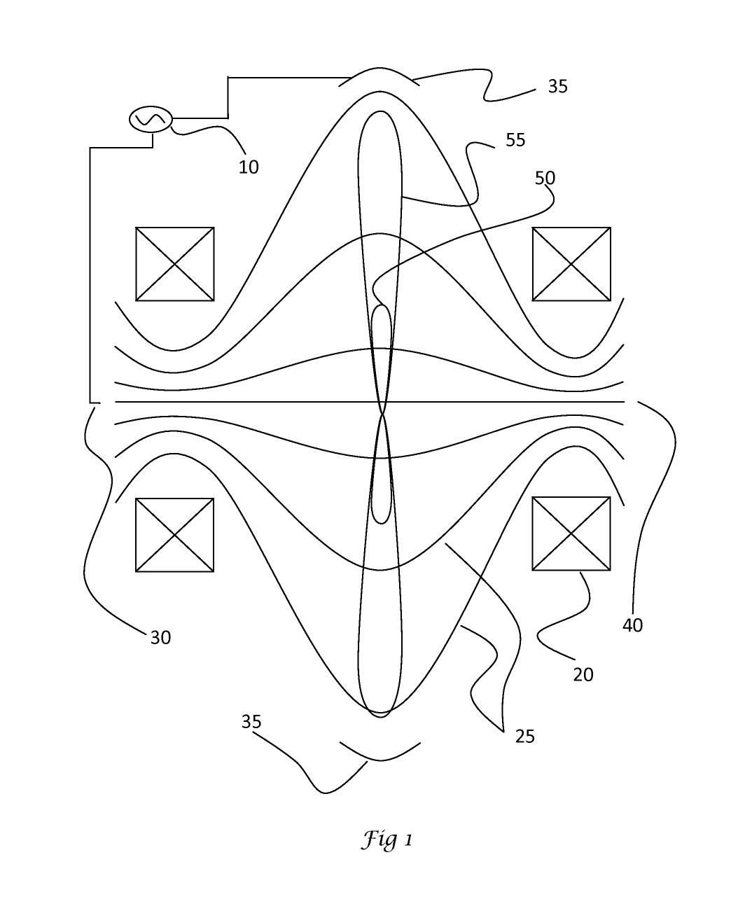

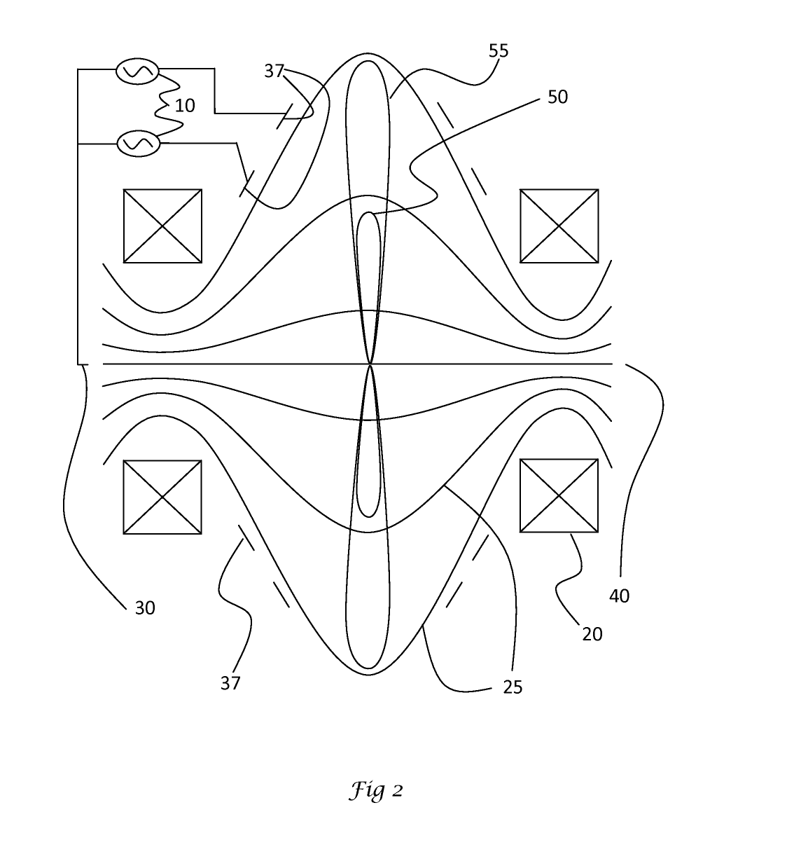

An alternate preferred embodiment of the present invention is presented in drawing FIG. 2. Wherein the numbered components are similar to those with the same numbering from FIG. 1.

FIG. 2 shows an axial cross section of a solenoid magnetic field 25 produced by magnetic field coils 20 in a vacuum space not shown having an axis of symmetry 40. FIG. 2 reveals an alternate preferred embodiment of the Centroidal Cyclotron. A number of intermediate peripheral electrodes 37 operating on either side of a trapped population of charged particles 50 and 55 are capable of setting a limit to the energy that the charged particles can attain. As the orbit radius increases beyond the radius of the peripheral electrodes the electric field decelerates the charged particles and therefore establishes a natural energy limit. Particles may continuously be introduced thereby without earlier particles 55 reaching excessive energy before later introduced particles 50 have the opportunity to be accelerated. The intermediate electrodes 37 which accelerate to a fixed energy, my be supplemented with any number of other intermediate and or peripheral electrodes as to modulate, accelerate and otherwise control the charged particle population as to achieve the objective of the present invention.

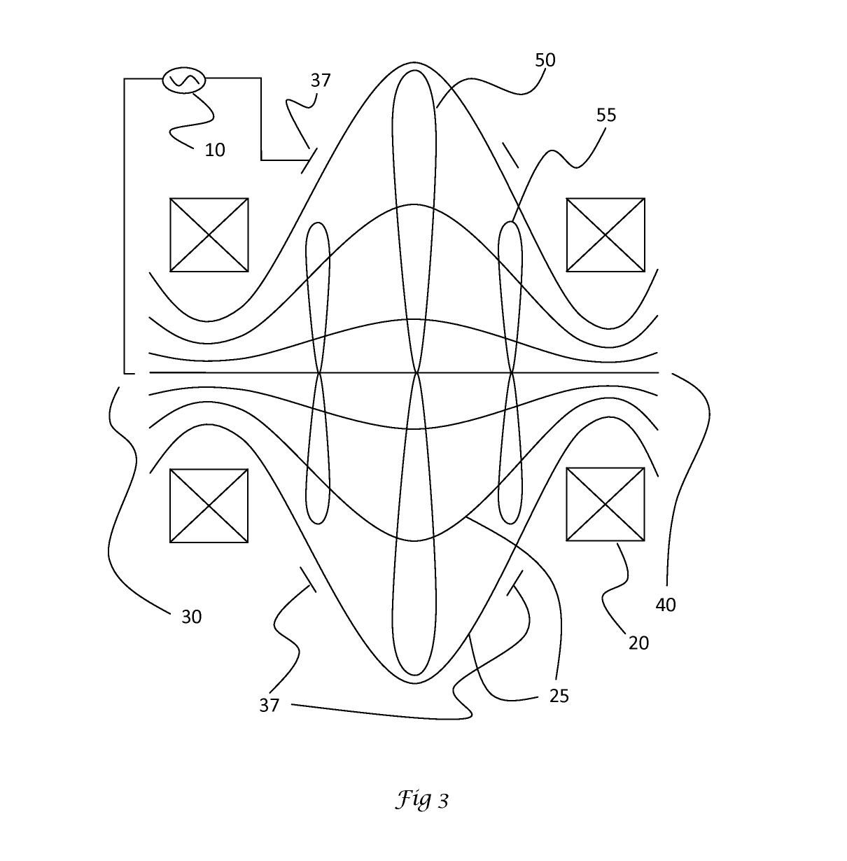

An alternate preferred embodiment of the present invention is presented in drawing FIG. 3. Revealing the principle of magnetic field trapping and positioning by virtue of RF frequency control. Wherein the numbered components are similar to those with the same numbering from FIG. 1. FIG. 3 shows an axial cross section of a solenoid magnetic field 25 produced by magnetic field coils 20 in a vacuum space not shown having an axis of symmetry 40. FIG. 3 reveals an alternate preferred embodiment of the Centroidal Cyclotron. A number of intermediate peripheral electrodes 37 operating on either side of a trapped population of charged particles 50 are capable of trapping charged particles 55 at a given magnetic field strength position. The frequency of the RF oscillator 10 determines the position in the magnetic field gradient that the charged particle shall be held 55. A charged particle will tend to be forced into a magnetic field strength depending on it's cyclotron frequency, which is magnetic field strength dependent. Electrodes 37 which trap the particles, my be supplemented with any number of other intermediate and or peripheral electrodes as to accelerate and trap the charged particle population as to achieve the objective of the present invention.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material of acts beyond the scope of the commonly defined meanings. thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements literally set forth, but all equivalent structure, material or acts of performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim. Likewise any positioning of elements as literally set forth is to be recognized as being representative of an example to teach and that alternate positioning of elements performing substantially the same function obtaining to the same result are defined to be within the scope of the defined elements. Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and what incorporates the essential ideas.

The scope of this description is to be interpreted only in conjunction with the appended claims and is made clear, here, that each named inventor believes that the claimed subject matter is what is intended to be patented.

### SEQUENCE LISTING

Not applicable.

1. An apparatus for manipulating charged particles within a vacuum magnetic field having a magnetic field axis and capable of confining charged particles moving orthogonal to the magnetic field axis, the apparatus comprising;
a magnetic field capable of having various values in time and, or along the magnetic field axis;
a pair of electrodes;
said electrodes energized by an electrical power source enabled to provide adequate voltages and currents at a controllable frequency, such as to establish varying electric potentials between the electrode pair in the region of the vacuum magnetic field;
one of the pair of electrodes is a virtual electrode, where the physical electrode is situated on the magnetic field axis but positioned axially out of the, orthogonal to the magnetic field axis plane of the charged particle orbits;
the second of the pair of electrodes is situated at the radial outer periphery of the charged particle orbits, beyond the charged particle's initial radial excursion extent, generally in the orthogonal to the magnetic field axis plane of the charged particle orbits;
ions confined within the magnetic field acted upon by the oscillating electric field such as to be accelerated orthogonal to the magnetic field axis, alternately, towards the axis and away from the axis on alternate polarity half cycles of the oscillating electric field;
the electric fields being established between the electrode pair such as to provide acceleration and position control to the charged particles confined within the vacuum magnetic field;
and said positioning of the charged particles controlled by particle charge to mass ratio and the frequency of the oscillating electric field as well as the magnetic field strength.

2. The apparatus of claim 1 comprising;
a magnetic field capable of having various values in time and, or along the magnetic field axis;
a pair of electrodes;
said electrodes energized by an electrical power source enabled to provide a controllable frequency, voltage and current oscillating electric potential between the electrode pair in the region of the vacuum magnetic field;
one of the pair of electrodes is a virtual electrode, where the physical electrode is situated on the magnetic field axis but positioned axially out of the plane of the charged particle orbits;
the second of the pair of electrodes comprising a set of electrodes situated on either side of the charged particle orbits at a radial extent that allows the orbits to pass freely between the second electrode set;
ions confined within the magnetic field acted upon by the oscillating electric field such as to be accelerated, alternately, towards the axis and away from the axis on alternate polarity half cycles of the oscillating electric field;
the electric fields established between the electrode pair such as to provide acceleration and axial position control of the charged particles confined within the vacuum magnetic field;
said acceleration determined by the radial positioning of the second set of electrodes and the voltage applied to the electrodes;
and said positioning of the charged particles controlled by particle charge to mass ratio and the frequency of the oscillating electric field as well as the magnetic field strength.

3. The apparatus of claim 1 comprising;
a magnetic field capable of having various values in time and, or along the magnetic field axis;
a plurality of electrodes;
said electrodes energized by an electrical power source enabled to provide a controllable frequency, voltage and current oscillating electric potential between the plurality of electrodes in the region of the vacuum magnetic field;
one of the plurality of electrodes is a virtual electrode, where the physical electrode is situated on the magnetic field axis but positioned axially out of the plane of the charged particle orbits;
a second of the plurality of electrodes comprising a set of electrodes situated on either side of the charged particle orbits at a radial extent that allows the orbits to pass freely between the second electrode set;
a third of the plurality of electrodes, situated axially on either side of the plane of the particle orbits and being situated at an intermediate radial extent between the first axial virtual electrode and the second set of electrodes;
further placement of the plurality of electrodes, situated at positions within the vacuum magnetic field space as to provide electric fields applied to the charged particles to further the present objective;
charged particles confined within the magnetic field acted upon by the oscillating electric fields such as to be accelerated, alternately, towards the axis and away from the axis on alternate polarity half cycles of the oscillating electric field;
said electric fields established between said plurality of electrodes in such manner as to control the energy and position of the charged particles confined within the vacuum magnetic field.

4. A method for manipulating charged particles, the method comprising the steps of;
a) providing a vacuum magnetic field having a magnetic field axis and capable of confining charged particles, and providing a pair of electrodes, and providing an electrical power source enabled to provide a controllable frequency, voltage and current oscillating electric potential between the anode and cathode electrodes in the region of the vacuum magnetic field;
b) introducing a source of charged particles therein;
c) one of the pair of electrodes is a virtual electrode, where the physical electrode is situated on the magnetic field axis but positioned axially out of the plane of the charged particle orbits, and a second of the pair of electrodes situated at the periphery of the charged particle orbits beyond the charged particle's maximum excursion;
d) energizing said electrical power source as to apply varying voltage and frequency electrical power to said electrodes as to accelerate and control the position within the magnetic field of the charged particles therein.

5. The method of claim 4, the method comprising the steps of;
a) providing a vacuum magnetic field having a magnetic field axis and capable of confining charged particles, and providing a plurality of electrodes, and providing an electrical power source enabled to provide a controllable frequency, voltage and current oscillating electric potential between the plurality of electrodes in the region of the vacuum magnetic field;
b) introducing a source of charged particles therein;
c) one of the plurality of electrodes is a virtual electrode, where the physical electrode is situated on the magnetic field axis but positioned axially out of the plane of the charged particle orbits, and a second of the plurality of electrodes comprising electrodes situated on either side of the charged particle orbits at a radial extent that allows the orbits to pass freely between the plurality of electrodes, and a third or more of the plurality of electrodes situated axially and radially on either side of the plane of the particle orbits;
d)) energizing said electrical power source as to apply varying voltage and frequency electrical power to said plurality of electrodes as to accelerate or decelerate and control the position within the magnetic field of the charged particles therein.

6. An apparatus and method for accelerating charged particles, comprising;
a means for establishing an oscillating electric field orthogonal to a magnetic field axis;
said means achieved by providing electrodes separated from one another radially as well as axially;
where one electrode is situated on the magnetic field axis, and another electrode situated off the magnetic field axis;
said electrodes capable of controlling electric field potentials provided by appropriate alternating potential electric power source;
said oscillating electric field capable of alternating between pointing inwardly towards the magnetic field axis and pointing outwardly away from the magnetic field axis.
